(19) United States
(12) Patent Application Publication
(10) Pub. No.: US 2017/0370257 A1
(43) Pub. Date: Dec. 28, 2017

(54) APPARATUS AND METHODS FOR CLEANING AND MAINTENANCE OF DIESEL EXHAUST FILTERS AND DIESEL PARTICULATE MATTER

(71) Applicant: Diesel Exhaust & Emissions, LLC, Santa Fe Springs, CA (US)

(72) Inventors: Jeramy Ostrander, Huntington Beach, CA (US); Brian Bowles, Fullerton, CA (US)

(21) Appl. No.: 15/688,698

(22) Filed: Aug. 28, 2017

Related U.S. Application Data
(60) Provisional application No. 62/355,696, filed on Jun. 28, 2016.

(51) Int. Cl. F01N 3/023; B01D 46/00; B01D 41/04

(52) U.S. Cl. CPC F01N 3/0233; F01N 3/0237; B01D 41/04; B01D 46/0068; B01D 2279/30

(57) ABSTRACT

Apparatus and methods are disclosed for cleaning diesel particulate filters (DPFs) or similar items. Various combinations of features include: a multi-cell cleaning head; contemporaneous/simultaneous cleaning from both directions through the DPF (controlled so that no cell is simultaneously pressured from both ends); rotary or other movement of the heads across a static DPF, or a combination of movements of the DPF and the head(s); controlled positioning of the DPF with respect to the heads; gravity collection of removed ash/debris, separate from internal filtering of air within a cleaning cabinet; and others.

### CROSS-REFERENCE TO RELATED APPLICATION

This application claims priority to U.S. Provisional Application Ser. No. 62/355,696, filed Jun. 28, 2016, the disclosure of which is incorporated herein by reference in its entirety.

### FIELD OF THE INVENTION

The present invention relates generally to diesel exhaust and diesel particulate matter, and more specifically to apparatus and methods for cleaning the diesel particulate filters (DPF) that are used to meet government environmental requirements. Persons of ordinary skill in the art will understand that the inventions herein may be useful for other applications as well, besides DPF cleaning.

### BACKGROUND

Diesel engines emit a complex mixture of air pollutants, including both gaseous and solid material. The solid material in diesel exhaust is known as diesel particulate matter (DPM). Most major sources of diesel emissions, such as ships, trains, and trucks operate in and around ports, rail yards, and heavily traveled roadways. These areas are often located near highly populated areas. Because of this and other factors and information, government agencies such as the California Environmental Protection Agency's Air Resources Board (see http://www.arb.ca.gov/research/diesel/diesel-health.htm) have taken action to require filtering of diesel engine exhausts. Various state and/or U.S. federal regulations require diesel trucks and buses that operate in California to be upgraded to reduce emissions. Among other things, relatively recent regulations include the requirements to reduce exhaust emissions by using exhaust filters that meet certain particulate matter (PM) filter standards.

To meet these requirements, trucks commonly are outfitted with one or more diesel particulate filters (or DPF), a device designed to remove diesel particulate matter or soot from the exhaust gas of a diesel engine. These filters can be relatively expensive, so cleaning and reusing the filter elements can be cost-effective. Equipment and services have been created to provide for cleaning of these DPFs.

Although there currently are some standard DPF sizes in the industry, and although their cross-sectional shape is usually circular, conceptually DPFs could be made in any suitable size and/or shape. The filters typically are relatively large and heavy, on the order of 50-100 pounds each, but certain filters can be 200 pounds or more. The material that is removed from the DPF during cleaning is considered hazardous waste and therefore it must be handled and disposed of in a safe and controlled environment. Such cleaning can itself be messy and can involve potential health hazards to the persons doing the cleaning and/or in the surrounding area.

An overview of one company's (FSX's) approach to providing cleaning apparatus and service for such filters is shown at https:/www.youtube.com/watch?v=0qmWa2dBpfg, and includes the steps and apparatus shown in the images in FIGS. 1A-1L. The filter is removed from a vehicle, tested, cleaned, and if possible, reused. Generally, the cleaning shown in this prior art approach includes (a) placing the dirty filter vertically within a cleaning cabinet, (b) blowing air downwardly through each single “tiny cell” (FIG. 1-I) one at a time (by rotating the filter and moving the single cell “cleaning straw” radially from the center of the filter to its outer edge so that every single cell eventually is treated), (c) capturing the removed dirt via a separate vacuum system, and then (d) retesting the filter to ensure that it is clean and reusable. Some of this is further described in the materials that company posted at http://www.fsxinc.com/site1/Competition/Scan-Pulse.html, including photographs of FSX products (FIGS. 1-M-A and 1-M-B) and a comparison of that company's technology to other prior art competitors' technology (see FIG. 1N).

FSX indicates in its foregoing materials that the FSX technology is covered by a patent, which may be U.S. Pat. No. 7,051,453, three figures of which are shown in the accompanying drawings as prior art FIGS. 1Q, 1R, and 1S (FIGS. 1, 5, and 6 respectively from that patent). That patent shows the DPF filter/trap 100 oriented horizontally and rotated adjacent non-rotating air nozzles. Specifically, the patent states (at col. 3,1. 19-25 and 31-35) that

“. . . air nozzles 102 are arranged so that they are in close proximity to the element 33 of the trap 101. This forces air in the direction through the element 33 and exits through the element 34 on the opposite side of the particular trap 101. Nozzles 32 [sic-102] do not touch against the surface 33. The nozzles 32 [sic-102] are in as close a proximity as feasible . . . the trap 101 [then] is turned on its axis so that the surface 34 is closest to the nozzles 32 [sic-102]. The second cleansing along axis 30 is from the direction of element 34 which is adjacent to the nozzles 32 [sic-102].”

Thus, the FSX '453 patent shows to rotate a DPF in front of a set of five fixed nozzles 102, around a central horizontal axis 30, and then switch the DPF's orientation to place its opposite end near the nozzles 102 and repeat the process a second time. The '453 patent thus not only requires two separate “cycles” of cleaning (one from each end of the DPF), but requires that the operator lift/move and reposition the DPF between the cycles and possibly reset/align the nozzles/equipment with respect to the DPF itself, so that the nozzles hit “all” the individual cells in the DPF. In practice (as opposed to being disclosed in the '453 patent), FSX does blow from both ends of the DPF simultaneously, although only through a single cell each direction.

Examples of other competitors' cleaning cabinets are shown at http://www.enviromotive.net/wp-content/uploads/2014/09/eb-9001.jpg (as shown in FIG. 1-O) and at http://puritechuk.com/binary/zc.pdf (as shown in FIG. 1-P). Other patents for other DPF cleaners include U.S. Pat. Nos. 8,241,403, 7,767,031, 7,357,829, and 8,256,060. All of these have shortcomings as compared to the present inventions.

### BRIEF DESCRIPTION OF THE DRAWINGS

The present inventions will become apparent from the textual description considered in connection with the accompanying drawings. It should be understood, however, that the drawings are intended for the purpose of illustration and not as limits of the invention. In other words, the present inventions are illustrated by way of example, and not by way of limitation, in the text and the figures of the accompanying drawings. In those drawings, like reference numerals generally refer to similar elements.

FIGS. 1A through 1L are screenshots of an online prior art video posted by FSX, illustrating a process and equipment that FSX uses to clean DPFs.

FIGS. 1M-A and 1M-B are screenshots of FSX prior art equipment, similar or identical to that used in the process of FIGS. 1A through 1L.

FIG. 1N is another online posting by FSX, comparing FSX equipment/processes (on the right) with third party DPF cleaning technologies (on the left).

FIG. 1-O is an online posting by another third party DPF cleaning company.

FIG. 1P is an online posting by yet another third party DPF cleaning company.

FIGS. 1Q, 1R, and 1S are copies of drawings from prior art U.S. Pat. No. 7,051,453 (FIGS. 1, 5, and 6 respectively from that patent).

FIG. 2 is a perspective view of one of the many embodiments of the present invention.

FIG. 2A is an angled upper view of the apparatus of FIG. 2, taken along the line 3-3 in FIG. 2 (from in front of and above the apparatus).

FIG. 3A is similar to FIG. 2, but shows the apparatus with a main cover/hatch partially raised, and with various other elements repositioned.

FIG. 3B is similar to FIG. 3, but shows the apparatus with a main cover/hatch removed.

FIG. 4 is similar to FIGS. 2 and 3, but shows many of the cleaning apparatus elements without much of the preferred containing cabinet positioned around them.

FIG. 5 is similar to FIGS. 2-4, but shows more of the preferred apparatus elements removed so that other elements (such as an adjustment mechanism to raise/lower the DPF) can be better illustrated.

FIG. 6 is similar to FIG. 2, but shows a perspective view from the other front corner of the apparatus, and has the main access door raised and a lower tray extended to the left.

FIG. 6A is a section side elevation view of the apparatus of FIG. 6, taken along the line A-A in FIG. 6B.

FIG. 6B is a front elevational view of the apparatus of FIG. 6.

FIG. 6C is a top view of the apparatus of FIG. 6.

FIG. 7 is an elevation view of one of the many embodiments of a blower/vacuum head with which the invention can be practiced.

FIG. 7A is an end view of the head of FIG. 7.

FIG. 7B is a perspective, partially sectional (upper right corner sectioned) view of the head of FIG. 7.

FIG. 7C is similar to the view of the head of FIG. 7, but shows the front surface removed to illustrate one of the many interior patterns and shapes for one or more vanes or fins within the head.

FIGS. 7D-G illustrate some of the many alternative shapes and sizes of opening for a head useful in practicing the invention, rather than the generally long, thin slot shown in FIGS. 7 and 7A-C.

FIGS. 8A-D illustrate schematically the relative positions of certain embodiments of the invention, showing heads relatively positioned with respect to a filter, and in FIG. 8D some of the many patterns of relative movement between the head(s) and the filter. FIG. 8A is a perspective view, FIG. 8B is also a perspective view (from a lower angle, showing a cleaning head underneath the filter), FIG. 8C is a side elevation view of the embodiments of FIGS. 8A and 8B, and FIG. 8D is a top view of the embodiments of FIGS. 8A and 8B.

### DETAILED DESCRIPTION OF EMBODIMENTS OF THE INVENTIONS

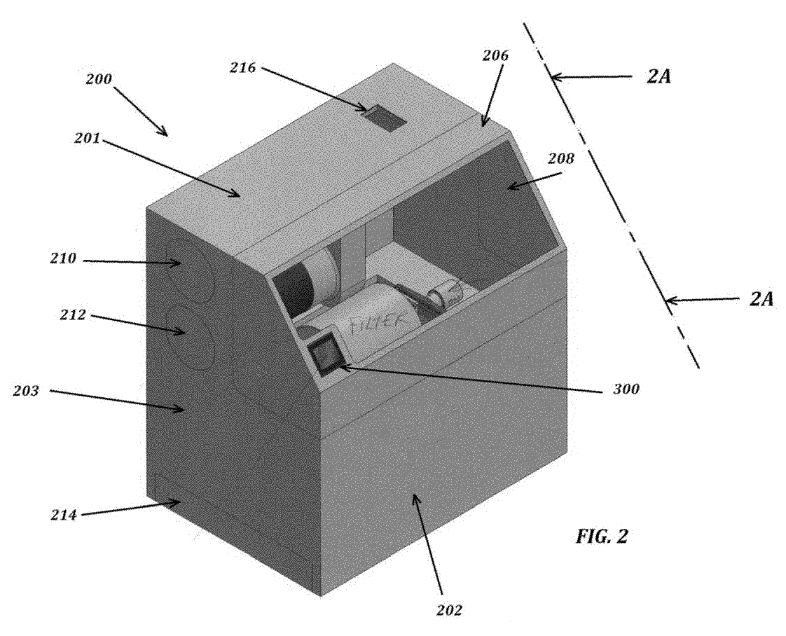

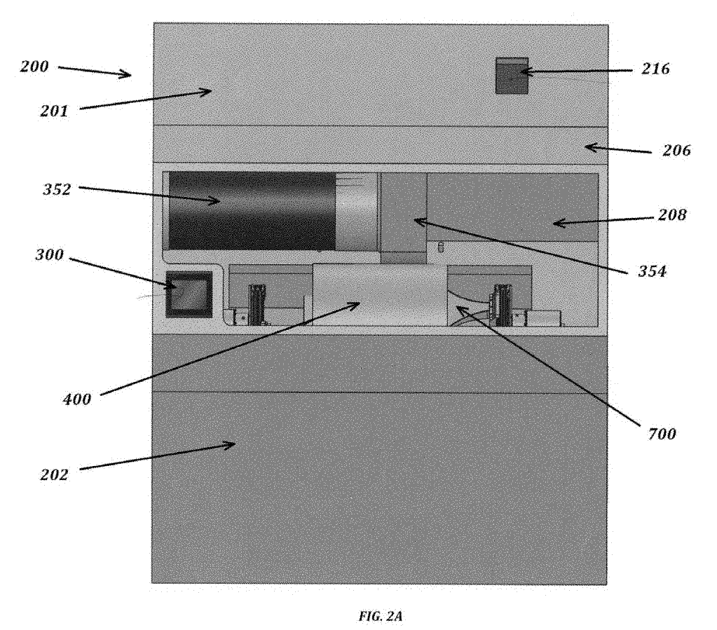

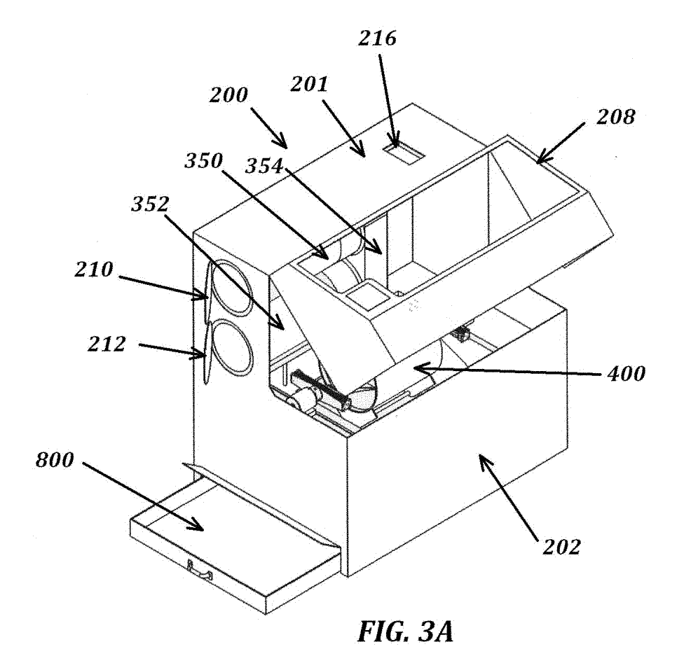

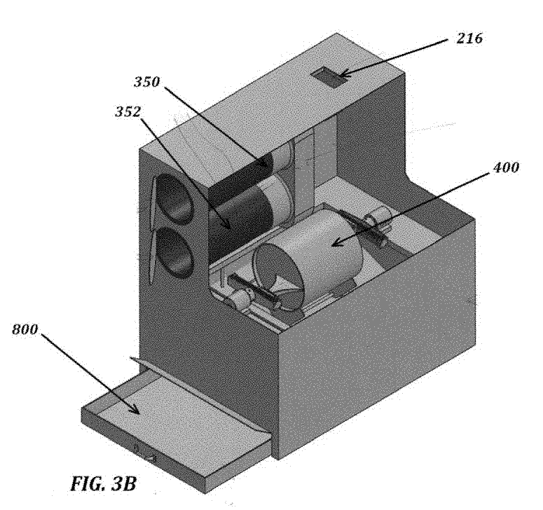

Various embodiments of the inventions are now described with reference to the drawings (including FIGS. 2-7), wherein like reference numerals generally are used to refer to like elements throughout. In the following description, for purposes of explanation, numerous specific details are set forth in order to provide a thorough understanding of one or more embodiments. It may be evident, however, that certain embodiment(s) of the invention(s) may be practiced without some or most of these specific details. In other instances, well-known structures and devices may be shown and/or described in representative block diagram form or described in terms known within the relevant industry, in order to facilitate describing one or more embodiments.

In the following paragraphs, the present inventions are described in detail by way of example with reference to the attached drawings. Throughout this description, the preferred embodiment and examples shown should be considered as exemplars, rather than as limitations on the present inventions. As used herein, the “present invention” or “the invention” or “the inventions” refers to any one of the embodiments of the inventions described herein, and any lawfully-covered equivalents. Furthermore, reference to various feature(s) of the “present invention” throughout this document does not mean that all claimed embodiments or methods must include the referenced feature(s).

Embodiments of the present inventions preferably provide apparatus and/or methods with certain functions similar to prior art systems for cleaning DPFs and/or other devices, but with numerous and various benefits and/or combinations of benefits that are not in the prior art. Persons of ordinary skill in the art will understand that the materials and components used herein can be any of a wide variety, preferably providing a sufficiently strong, lightweight, durable system to safely and reliably function as described herein. The air pressure and/or electrical/control/sensing components can be selected and/or adapted from ones that are commercially available, and/or can be customized for a particular application. Many of the components (including the structural/support components) preferably are metal, and can be painted or otherwise treated depending on the application(s) for which the particular embodiment is intended.

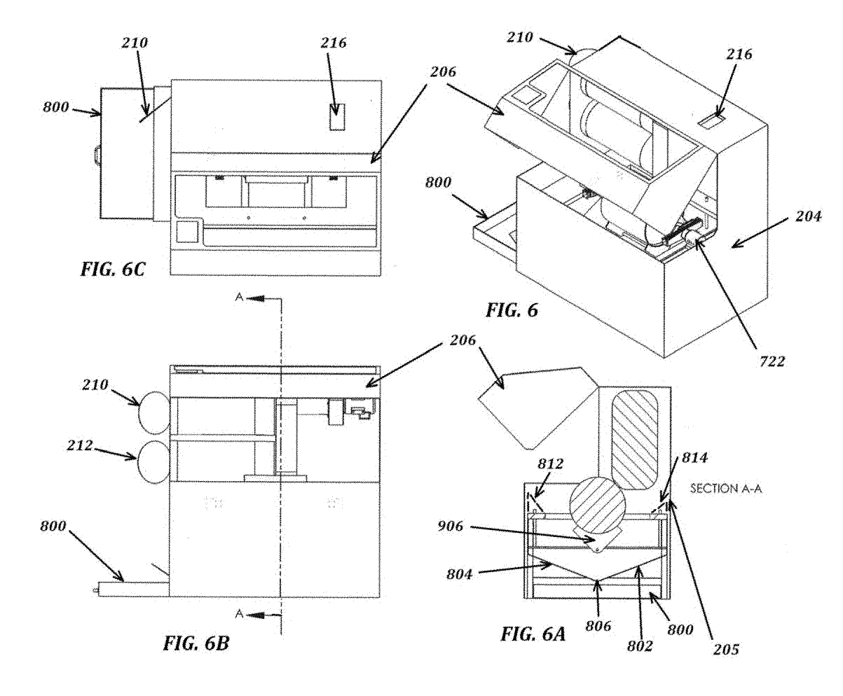

Among other things, FIG. 2 shows a perspective view of one of the many embodiments of apparatus that can be used to practice one or more of the inventions. It shows a closed cabinet 200 preferably effectively sealed so that the cleaning actions inside the cabinet 200 do not result in dispersion of particulate matter outside the cabinet 200. As shown, the cabinet 200 includes a top panel 201, a front panel 202, and side panels 203 and 204 (FIG. 6), and a back panel 205 (FIG. 6A), and a bottom panel(s) as described herein, but persons of ordinary skill in the art will understand that the cabinet 200 can be provided in any of a wide variety of suitable shapes and/or sizes, so long as the cabinet 200 has sufficient space inside to contain the DPF filter and other elements and/or combinations of elements described herein, and permit the cleaning process(es) described herein. Persons of ordinary skill in the art will understand that certain advantages of the invention can be provided without a sealed cabinet, and/or with a partially-enclosed/sealed cabinet.

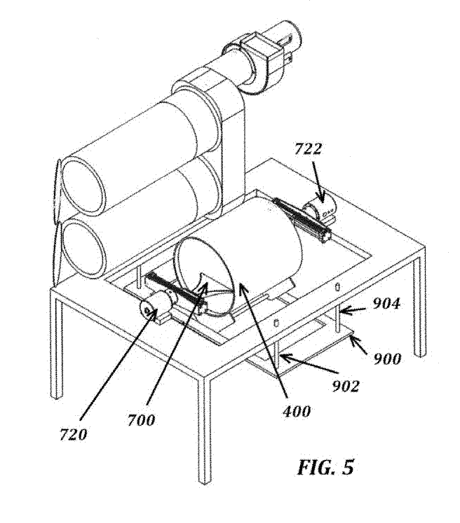

In the drawings, a DPF filter 400 preferably is mounted or otherwise operatively positioned inside the cabinet 200 for purposes of cleaning particulate matter from the filter 400, in hopes that the filter 400 can be re-used. The filter 40 preferably is oriented so that its centerline is at least generally horizontal. Preferably the filter's position can be selected and/or adjusted using a mechanism such as the lift/dolly system shown in FIG. 5. In that FIG. 5, a DPF 400 is located on a support platform 410, and the vertical position of that platform 410 (and the DPF) is adjusted using one or more vertically oriented rods 412. Persons of ordinary skill in the art will understand that this adjustment can be made manually or automatically, using any of a wide range of drives, power sources, controls, or the like. Similar lateral adjustment (positioning the DPF to the right or left, or further toward the back/front of the cabinet 200) can likewise be accomplished by any suitable manual and/or automated apparatus and/or process. Depending on the embodiment, the “entry” of the filter 400 into the cabinet can be provide from underneath, such as through an opening (not shown) in front panel 202.

Preferably, a main hatch 206 is provided to enable ready access to the interior of the cabinet 200. Among other things, a hatch or cover 206 can enable other ways in which a DPF can be placed into and/or removed from the cabinet 200, such as manually, or with a lift/crane (not shown.

The embodiments shown in the drawings includes a clear viewing panel 208 that is shown as part of the cover 206, but persons of ordinary skill in the art will understand that it can be positioned in a wide variety of locations on the cabinet 200, and indeed more than one such viewing port/panel can be provided. The viewing panel/opening preferably provides visual confirmation of the status and activity within the cabinet 200. The panel can be plastic, glass, or other suitable material. Among other alternatives, the activity inside the cabinet can be monitored via video camera and/or other sensors, and viewed/monitored locally and/or remotely.

Preferably, the cleaning of the DPFs 400 is accomplished by at least one cleaning head 700 positioned near an end of the DPF. Also preferably, compressed air or other gas is blown into each end of the DPF 400 simultaneously (preferably through one or more head(s) 700 at each end of the DPF), although not into the ends of the same cell(s) at the same time (blowing into both ends of the same filter cell simultaneously would diminish or eliminate any net cleaning that occurred within that cell). By blowing simultaneously, the time required for a cleaning “cycle” is reduced by half (as compared to systems that blow only from a single direction), plus the time saved that would otherwise be required to “reverse” the DPF after cleaning is completed by blowing in one direction. Accordingly, in the attached drawings, at least one head 700 preferably is provided at each end of the DPF 400 (although persons of ordinary skill in the art will understand that even more such heads can be provided in other of the many alternative embodiments of the inventions).

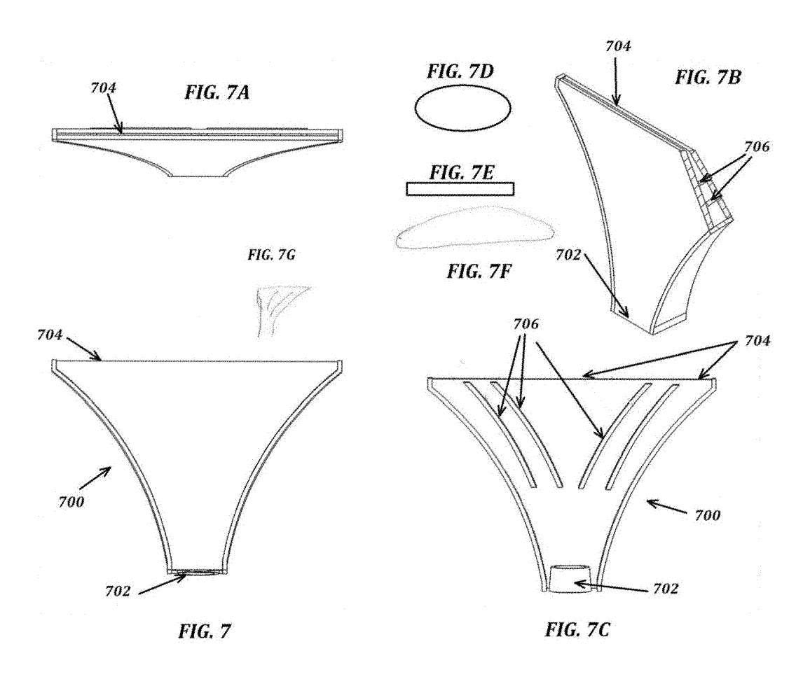

Persons of ordinary skill in the art will understand that, depending on the application, the head(s) 700 can be configured in a wide variety of shapes and sizes, preferably are readily interchangeable with other head(s) 700 (via quick-connects for compressed air lines, or other connection apparatus) to provide easy customization of the cleaning process to better match a specific DPF and/or its condition. Preferably, the head(s) 700 can have any of a wide range of openings positioned adjacent the DPF 400 (see examples of FIGS. 7D, 7E, 7F, and 7G, in addition to the “slot” embodiment illustrated in FIGS. 7 and 7A-C). In other word, the inventions can be practiced with other head outlet shapes (oval, round, longer, wider, triangular, etc.). In certain embodiments, a head 700 may have a relatively wider blow opening/slot at that portion of the head that will be over the “periphery” of the DPF, so that if the head is rotated around the centerline of the DPF, more air will likely be blown out that wider area than is blown out the head nearer the centerline itself, because the head will need to clean more cells at the periphery than at the centerline. The cross-sectional shape of that opening can even be proportional to the radius of the DPF, to achieve an approximate balanced distribution of blown air equally over all the cells in the DPF.

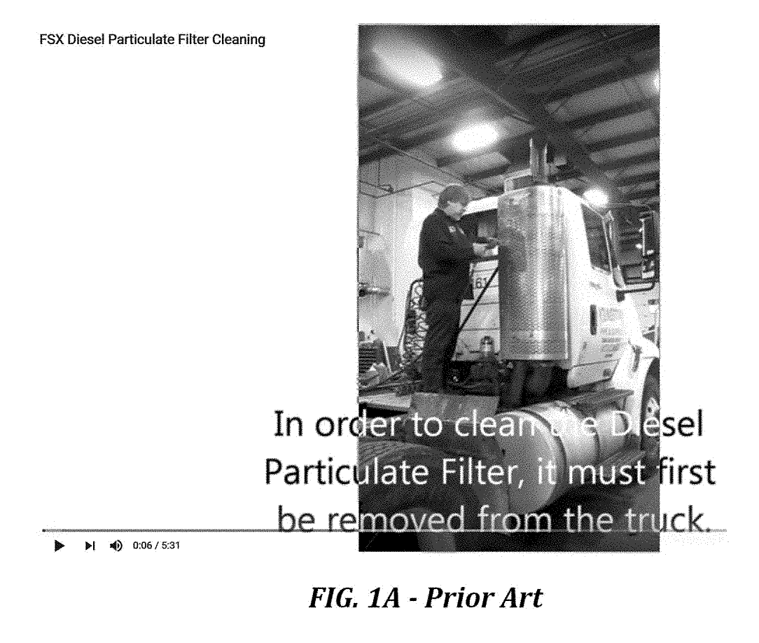

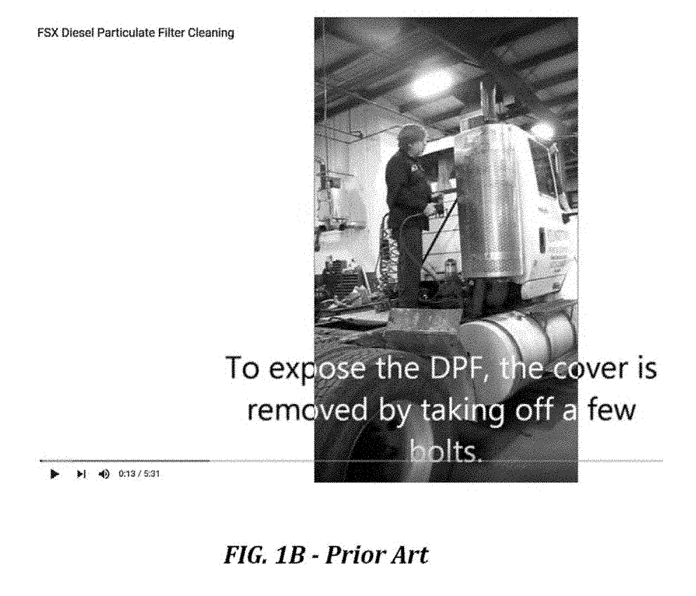

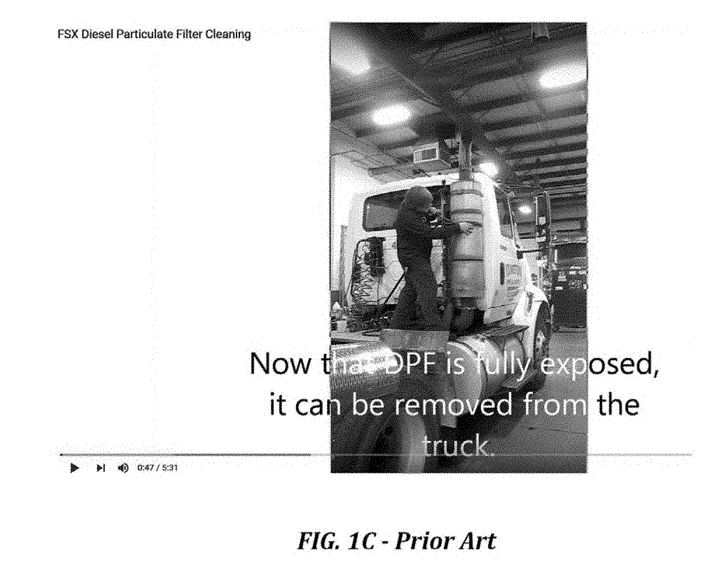

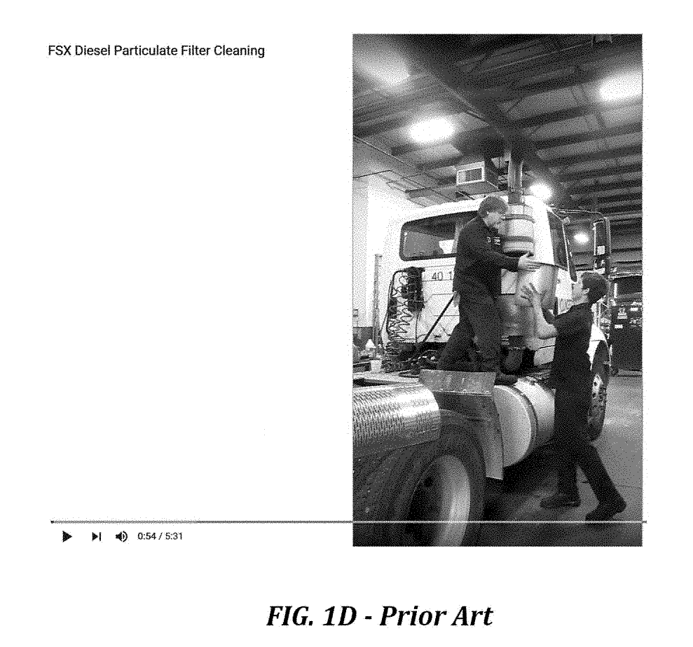

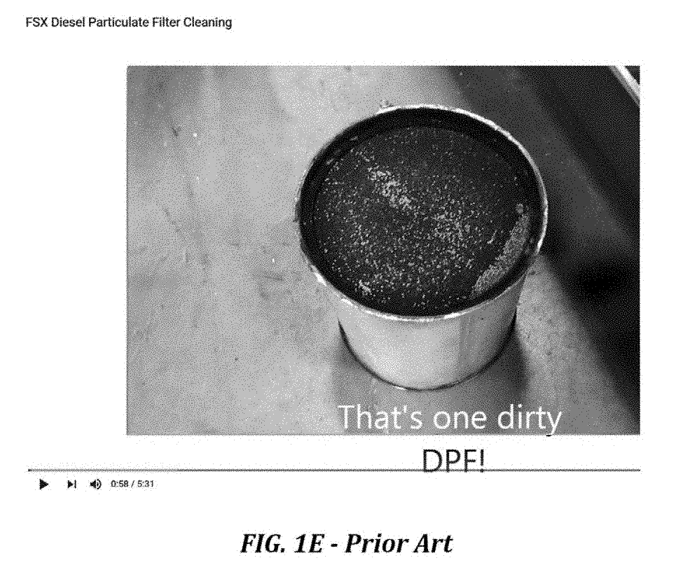

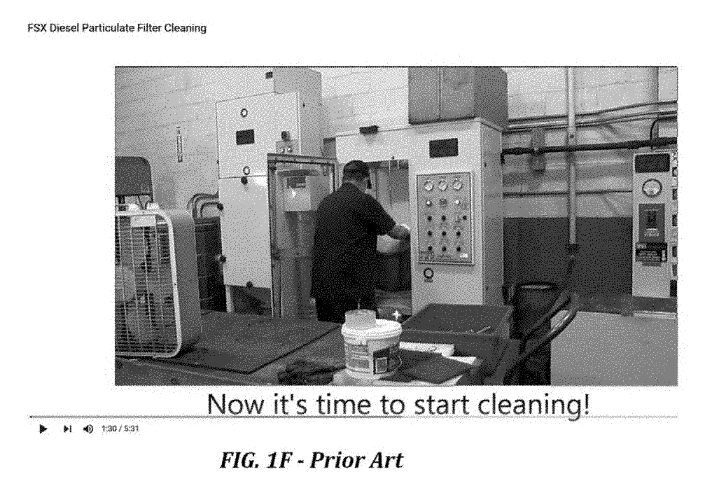

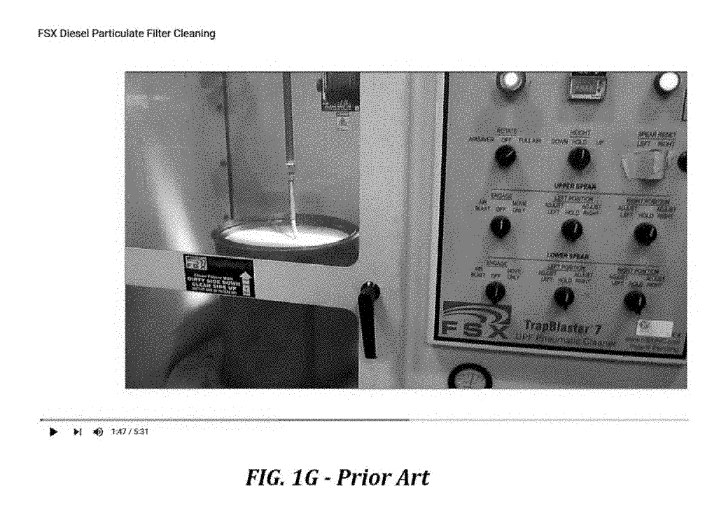

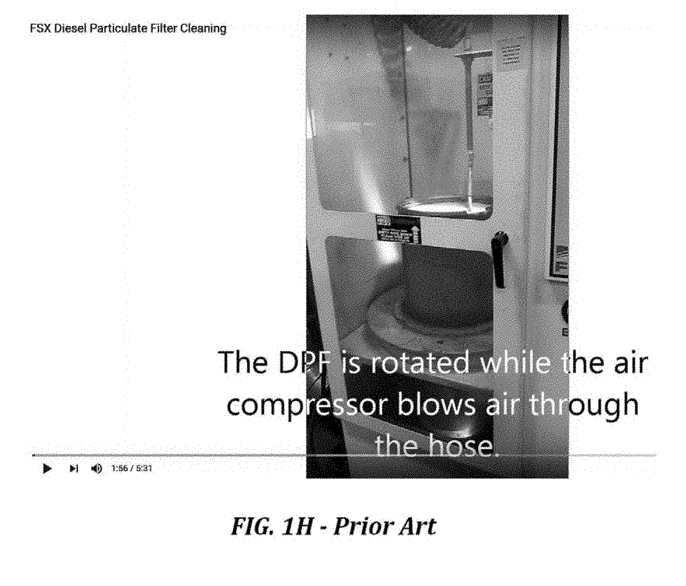

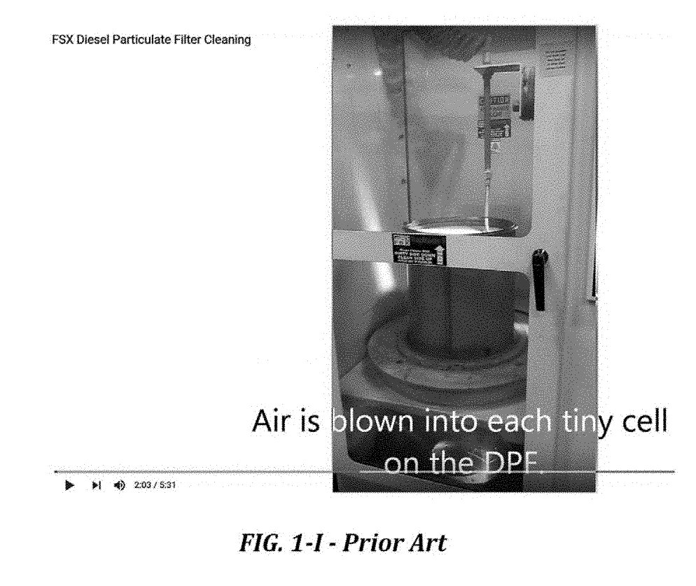

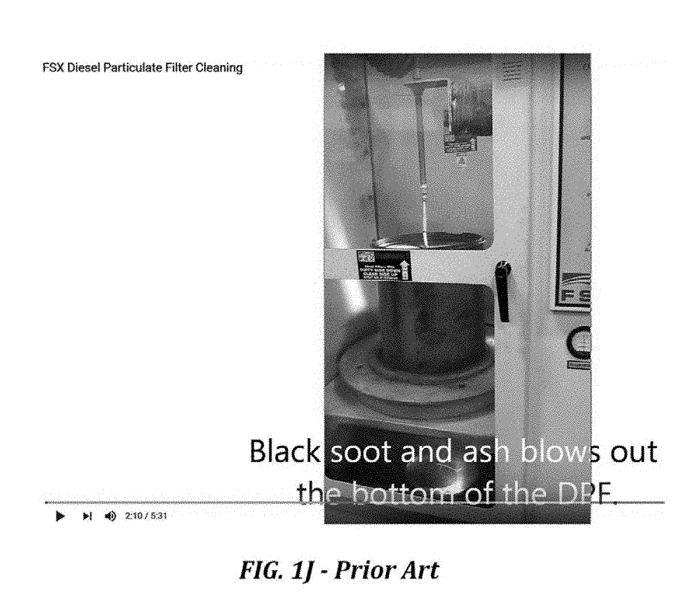

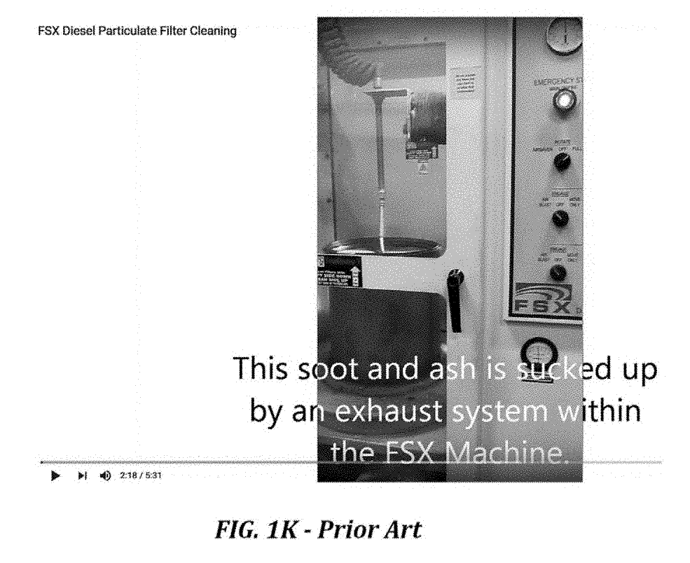

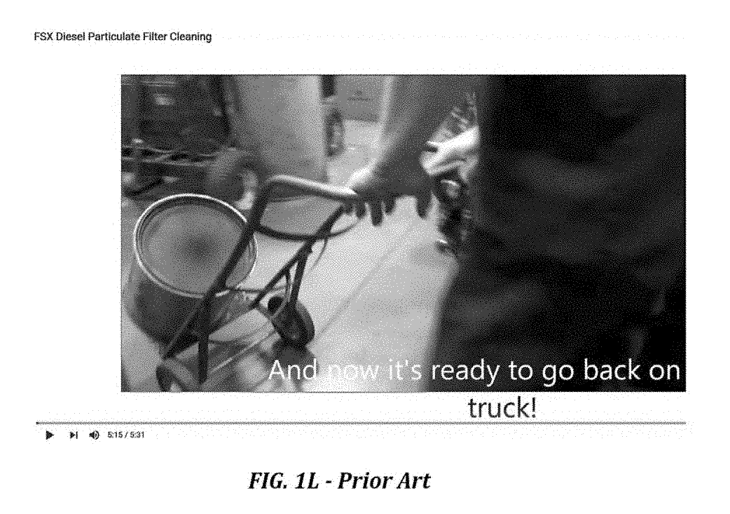

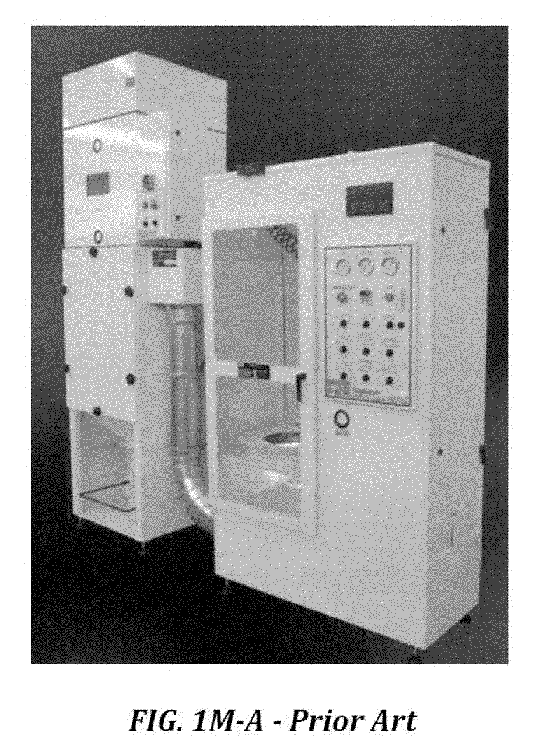

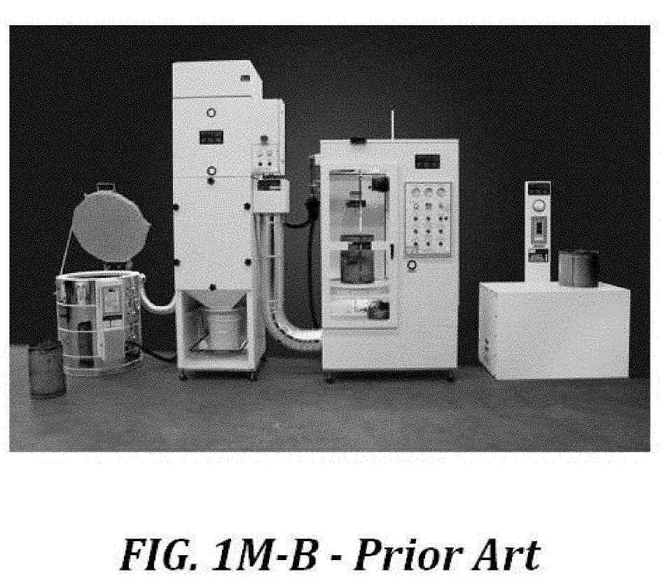

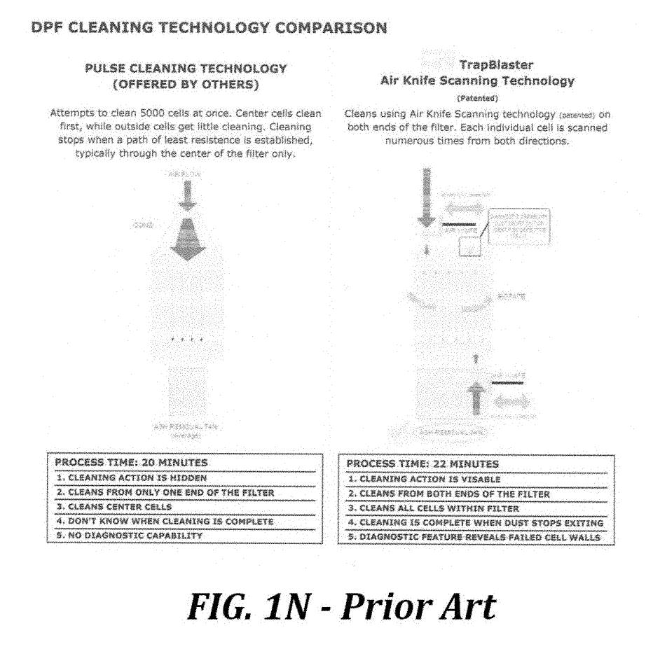

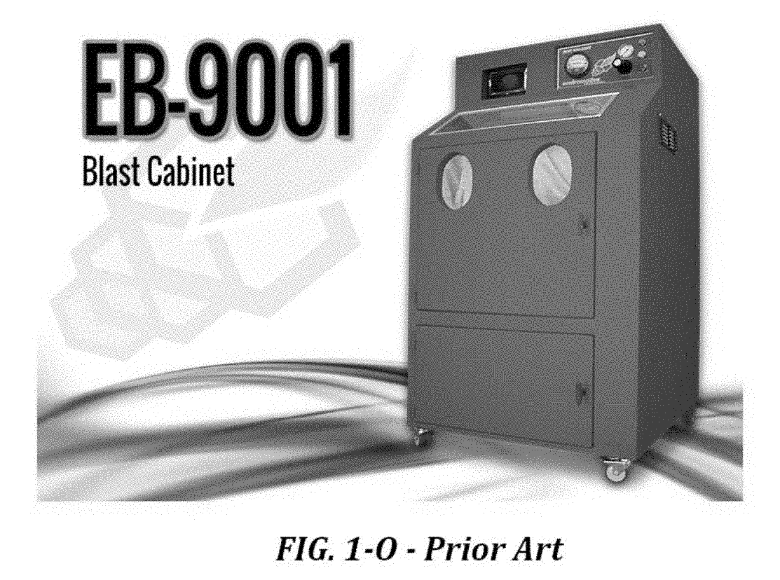

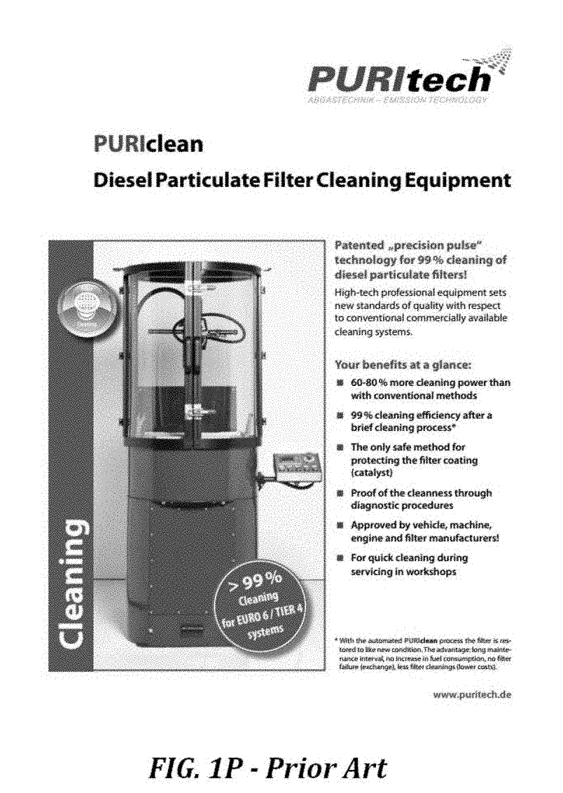

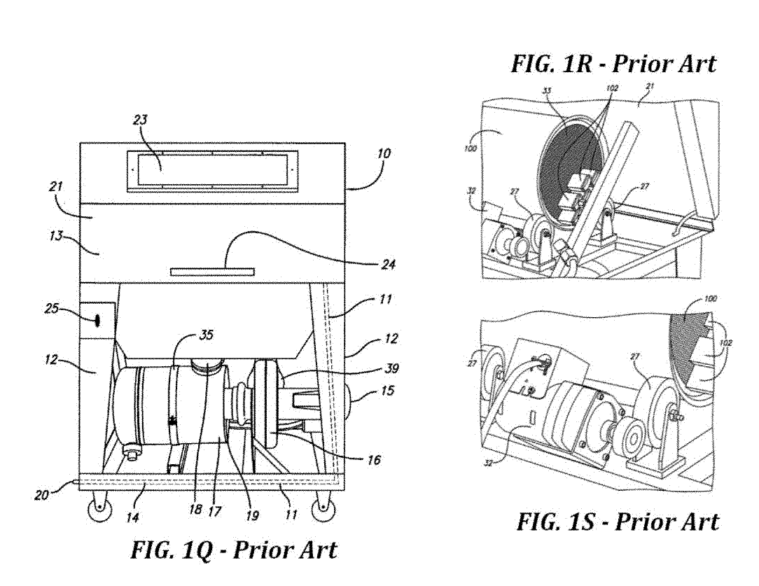

By providing an extended/enlarged blowing area or channel (a slot as shown in FIG. 7A for example, or otherwise enlarged or widened beyond a single “DPF cell” coverage), more than one cell can be covered by the head 700 at a given time, so more of the DPF is being cleaned at each point of the cleaning cycle (as compared to the above prior art “straw” that FSX uses to clean a single cell at a time). For example, U.S. Pat. No. 7,051,453 shows five tips (see air nozzles 102 in FIG. 1R herein), but each of those air nozzles 102 apparently is for a single cell. Preferably, embodiments of the present inventions cover a range or plurality of cells simultaneously. Also preferably, the nozzles/head(s) of the present inventions preferably are positioned about an inch away from the surface of the DPF, to prevent damage to the DPF (such as to its coating).

In certain embodiments of the present inventions, the air being blown (preferably, or vacuumed in other embodiments) can be dispersed from the head 700 in any suitable manner, to ensure generally equal air flow/force across all of the opening 704 and thereby generally equal blowing/cleaning force applied to all of the DPF cells over which the head 700 is positioned at a given time. Among the many ways to accomplish such dispersion is the provision of vanes or fins 706, FIGS. 7B and 7C. Persons of ordinary skill in the art will understand that the number and relationship and size and shape of any such dispersion elements or structures can be any of a wide variety, and can be fabricated in any suitable manner and from any suitable material. Preferably, the head(s) 700 (whether using vanes or not) are configured to assure good dispersion of the air being blown out, so that all of the cells being covered by the head(s) at a given time have desired cleaning action. In some embodiments, a thin strip opening for the air from the head(s) 700 may cover 15 cells at a time, although persons of ordinary skill in the art will understand that the precise number of cells covered can vary depending on a number of factors and design considerations.

Preferably, the head(s) 700 are selectable and readily interchangeable, so that they can be “matched” with the particular model/size of DPF being cleaned (to either cover the width of the DPF in a single pass/rotation or two/three/etc. passes/rotations), and/or to the condition of the DPF, and/or in view of other factors. Also, the inlet or neck 702 of the head 700 preferably is configured to receive pressurized air or other gas, such as from an air chuck nozzle (not shown), in the range of 90 psi or whatever suitable pressure is available and/or effective for the desired cleaning (without damaging the DPF). Persons of ordinary skill in the art will understand that the neck 702 can be any suitable cross-section, size, location, etc. (including by way of example off-center/offset with respect to the outlet 704, as shown in FIG. 7G).

A pressure regulator can be provided in or near the head 700, and one or more hoses and/or air compressors (not shown) can provide the desired/needed air for cleaning the DPFs. Among other things, such compressor(s) and/or hose(s) can integrally assembled with the apparatus 200 in a relatively permanent arrangement, or the unit 200 can be portable and configured to be connected to other sources of pressurized air.

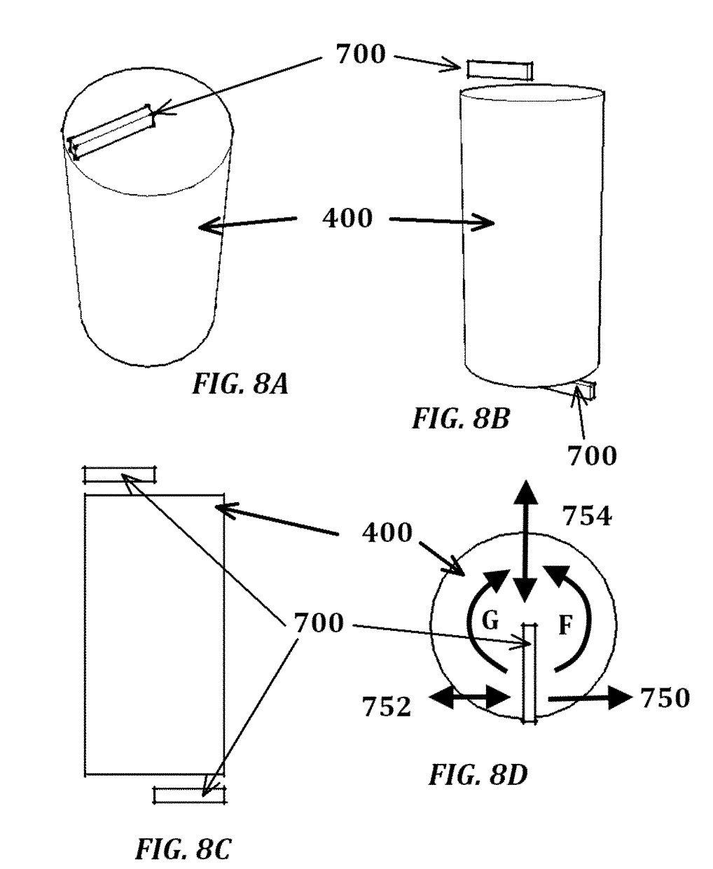

In certain embodiments, the system preferably keeps one end of the head(s) 700 in or adjacent or covering the “centerline” of the DPF while the head rotates around that centerline 360 degrees. A few of the many examples of such “cleaning patterns” for movement of the head(s) over the end of the filter are shown in FIGS. 8A-D. In those embodiments, two heads 700 are offset with respect to each other (so that they do not blow into the same filter cell at the same time). There inner edges preferably are at or adjacent the centerline of the filter. The movement pattern can be rotational (as in arrows F or G in FIG. 8D) or lateral (as indicated by arrows 750, 752, and 754 in FIG. 8D). Persons of ordinary skill in the art will understand that such patterns can be combined and, as indicated above, the lower/underside head 700 is preferably intentionally out-of-sync with the upper head 700 so that they do not blow into the same filter cell at the same time.

Among the many alternative embodiments of the inventions, other head/rotation patterns can be used (for example, a plurality of head(s) 700 can be positioned at one or both ends of the DPF. If three “heads” at provided and positioned at 120 degrees from each other (or a single “Y” head provides the same effective shape and/or delivery pattern), the relative rotation of the heads over the end of the DPF can cover the entire DPF end with a single rotation of 120degrees (instead of 360 degrees). Two or four heads, or other numbers or shapes or orientations of heads can likewise be used in various embodiments of the inventions. So long as a plurality of DPF cells and/or opposite ends of the DPF are being cleaned contemporaneously, such embodiments of the present inventions can provide faster and/or more efficient cleaning of a given DPF, as compared to certain prior art systems.

In addition, preferably each such head 700 is configured to rotate or otherwise move across the entire end of the DPF. For embodiments such as shown in FIG. 5, for example, one or more motors 720 and/or 722 can be actuated by air, electricity, hydraulics, or other power to rotate the head 700 around a central longitudinal axis of the DPF 40, so that a single 360 rotation makes the head pass of the entire end surface of the DPF.

Other of the many embodiments of the invention can include not just rotary or other movement of the head(s) 700 across a static DPF, but a combination of movements of the DPF and the head(s), preferably with the result that all cells of the DPF are cleaned within a given cleaning cycle. Among other things, a static head 700 preferably can be sized/selected so that it is as wide as the widest portion of the end of the DPF, and the “lift” function of the apparatus of the inventions can be used to raise/lower the DPF “across” the non-moving head(s) 700. Other of the many embodiments (not shown) include providing multiple parallel rows of head(s) 700 at each end of the DPF, all pressurized and operating simultaneously, so that all of the DPF cells get cleaned in a shorter cycle time (each row of heads would only have to clean a portion of each end, with the combined rows effecting the cleaning of the “entire” end of the DPF).

Still other embodiments can include having additional “sets” of head(s) 700 within a given cabinet 200, positioned so that more than one DPF can be cleaned simultaneously/contemporaneously. Such embodiments permit an operator to set the machinery for cleaning of those multiple DPFs and, within the approximate same time frame as would be required for a single DPF, return to the apparatus to have all of the multiple DPFs cleaned.

Persons of ordinary skill in the art will understand that these various features and/or embodiments can be used to reduce (and thereby improve) the cycle time required for cleaning a given DPF (or DPFs). Even the embodiments with only the extended blowing slots such as shown in FIG. 7 (and none of the other improvements/features herein) can provide cleaning cycle time over single-cell “straw” cleaning of various prior art approaches. Preferably, cleaning cycles can be reduced to the order of 15 minutes to complete one blow-out of a given DPF (another similar 15-minute cycle may be used following an intermediate “bake” of the DPF filter after the first cycle, which baking helps turn any residual debris into white ash that can be easier to remove/blow out during the second cycle). Prior art apparatus such as those shown in the FIGS. 1 series herein apparently takes approximately 45 mins to an hour to accomplish those two cycles, so cleaning time can be reduced significantly with the present inventions.

Preferably the inventions can be programmed or otherwise used in various “cycles” of cleaning. For automated embodiments, a variety of cycles may be programmed and/or controlled (such as via a control panel such as panel 300), allowing a user to select a pre-programmed cycle for a given DPF model/size/etc. Such cycles preferably position/move/rotate the head(s) 700 with respect to the DPF so that air/gas is blown through every cell from each direction (not at the same time). Preferably the motion of the head(s) 700 with respect to the DPF is actuated by a controlled programmed apparatus, such as via pneumatic or hydraulic pressure, electrical or magnetic solenoids or other drives, or the like.

Again, persons of ordinary skill in the art will understand that the dimensions, shape, materials, and other characteristics of the components described herein (hatch, viewing panel, control panel, pneumatic power, etc.) can be any of a wide range and still provide some or all of the functionality needed or desired for a particular embodiment and/or application of the inventions.

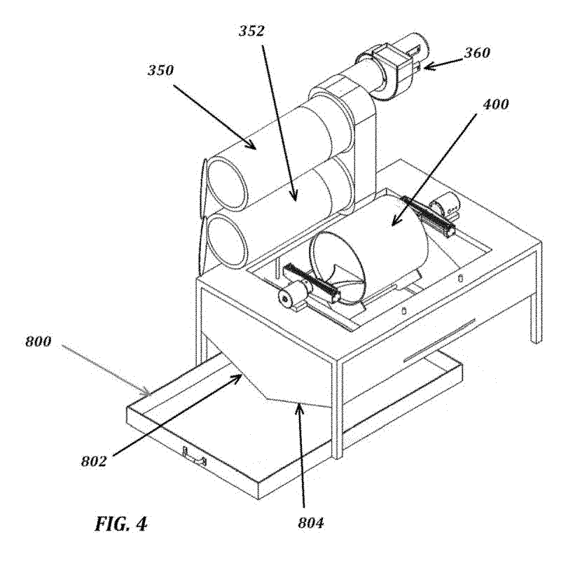

Certain embodiments of the inventions preferably also include an integrated air filter system such as one or more filter elements 350 and 352. Such an air filter/collection system can be mounted or otherwise provided externally to the main cabinet 200, but preferably the system is provided integrally with the cleaning cabinet 200, so that its dust collection apparatus/system is integral with the cleaning cabinet 200 and thus may require less or smaller pieces of ducting and/or other hardware to operate (and so that it will be portable with the complete cabinet 200, in embodiments of the inventions that include such portability). Preferably, these air filters 350/352 are accessible through hatches 210 and 212, respectively, and their exhaust is vented through a vent/opening such as vent 216. Input air/pressure can be provided via the operation of air blowing through the head(s) 700 and/or from some other external source (not shown), and/or an exhaust fan assembly 360 (FIG. 4) preferably is provided to pull air from the interior of the cabinet 200, filter it in the filter(s) 350/352, and then exhaust the filtered air from the cabinet via the vent 216.

Preferably the air filter system and vent are positioned generally in the “upper” portion of the cabinet or chamber 200, so that heavier debris elements blown from the DPF have the opportunity to “fall” to the bottom of the cabinet as discussed herein, rather than relying upon the air filter to process all of the debris from the DPF. In other words, preferably the air filter system captures the lighter dust in the air that results from blowing out the DPF. This means that the air filter system such as filters 350 and/or 352 are able to operate for longer periods than would otherwise be possible, before the filters 352/350 themselves need to be cleaned or replaced. Preferably filters 352/350 are HEPA filters, but persons of ordinary skill in the art will understand that a range of suitable filters may be use beneficially in certain embodiments of the invention. A manifold 354 preferably is provided to connect the exhaust(s) of the filters 352/350 to the vent opening 216.

Persons of ordinary skill in the art will understand that the filter(s) 350/352 and/or their respective access panels 210/212 can be any of a wide range of sizes and shapes and materials and functional specifications, and preferably are sufficiently sized with appropriate filtering rating and capacity to clean the air inside the cabinet 200 during and/or following a cleaning cycle within a reasonable amount of time. Among other things, by cleaning the air inside the cabinet 200 within a reasonable time, an operator or user of the apparatus of the inventions can view the clarity of the air through the viewing panel 208, and thus visually check the status of the cleaning cycle (clean air would indicate that no debris is being blown from the DPF and thus it is clean). The viewing panel preferably also permits users to confirm that the apparatus is operating throughout the course of the cycle, by permitting the user to see the head(s) 700 traveling across the end(s) of the DPF(s).

Certain embodiments of the inventions also can include one or more baffles (not shown) around and/or near the filters 350/352, to even further ensure that gravity has a sufficient opportunity to pull ash/debris down toward the tray(s) 800. Such baffles can be located to generally or partially encase the filters 350/352, and/or to be between the DPF and the filters 350/352. Ash/debris that may remain in the air that enters the filters 350/352 or may be blown upwardly toward the filters 350/352 preferably will tend to hit the baffle(s) rather than going straight into the filter(s) 350/352, and will effectively be knocked from the air and fall toward the tray(s) 800. As mentioned elsewhere, such baffles or similar structures can reduce the load on the filters 350/352, and can extend the life and/or need for maintenance of the filter(s) 350/352.

Certain embodiments of the inventions can include one or more air quality sensor(s), to automatically and/or continually check whether the air has been sufficiently cleaned inside the cabinet. Such sensors can be tied to the control panel 300, and/or can signal the system to “shut-off” the current cleaning cycle (because no further ash/debris is being blown out of the DPF).

Among additional benefits of the viewing panel, it preferably allows diagnosis as to whether the DPF is cracked/damaged. As mentioned above, the one or more viewing panels can be any of a wide range of sizes/shapes/etc. to permit various beneficial viewing. DPFs typically have an arrow on their exterior that marks the flow path for exhaust through the DPF. Although air can be blown through the DPF in both directions, debris should be “stopped” or filtered in the marked airflow direction, if the filter is still functioning properly. Accordingly, during a cleaning cycle in the cabinet 200, debris/ash should only be coming out through “inlet” side of the DPF, not out the outlet side of the DPF. If ash instead is coming out outlet side, the DPF most likely is damaged/cracked internally. The viewing panel 208 preferably permits an operator to check for such damage during a cleaning cycle (normally near the beginning of the cycle). If the operator sees that ash/debris is being blown out of the “outlet side”, the operator can assume that the DPF has lost its structural integrity and is allowing ash to go through the DPF rather than having that ash filtered/caught by the DPF.

The apparatus of the inventions also preferably includes one or more trays 800 (that can be slid into the cabinet 200 and covered with an access panel/door 214) for debris collection, to collect ash/diesel particulate matter that has been removed from the DPF. The tray(s) 800 can be any suitable size, shape, and volume, and are preferably fabricated from strong, lightweight material so that they may be readily inserted and removed and manipulated both empty and when debris is in the tray(s). Preferably, gravity urges the ash/debris that is blown from the DPF down toward the tray(s) 800, and sloping sides along the bottom of the cabinet 200 (such as indicated at 802 and 804 in FIGS. 4 and 6A) further urge the debris toward one or more openings in the cabinet bottom (such as at or near location 806 in FIG. 6A) that is generally centered over the tray(s). In certain embodiments, one or more one- or two-inch slots/openings in the cabinet bottom above the tray will be sufficient. Persons of ordinary skill in the art will understand that the bottom of the cabinet 200 can also slope inwardly/downwardly from one or both of the sides 203 and/or 204, instead of and/or in addition to from the front 202 and the back of the cabinet.

Preferably, the sloping sides and/or other elements on the interior of the cabinet 200 are sized, positioned, and/or angled, and/or are coated with a slick surface, sufficiently to prevent ash/debris from accumulating on any area of the cabinet interior. Any buildup on ledges or inside the cabinet 200 preferably can be cleaned by vacuum cleaner or similar device (not shown) between DPF cleaning cycles, and/or further/steeper sloping surfaces (such as shown in dashed line examples at locations 812 and 814, FIG. 6A) can be provided within the cleaning chamber 200 to similarly help to reduce/eliminate any debris buildup other than in the tray(s) 800.

Persons of ordinary skill in the art will understand that the opening(s) 806 over the tray(s) 800 can be any suitable size and shape, and that, depending on a number of factors, the size of tray(s) 800 may require it to be emptied during the cycle. Preferably, however, the tray(s) 800 is of sufficient size (capacity) for several DPFs to be cleaned without having to empty it. Persons of ordinary skill in the art will understand that the debris collected in the tray(s) 800 is then handled in accordance with any and all relevant laws and regulations, through its final disposal.

In addition to the preferred angled sides to feed debris generally into the center of the tray(s) 800, preferably the cabinet 200 includes one or more vibrators, operably positioned to selectively shake the air filter(s) and/or the DPF filter(s) in the cabinet, to further loosen and/or urge the debris/ash to fall from the DPF, and/or to shake the cabinet 200 to urge any collected debris/ash to slide down toward and into the tray(s) 800.

Preferably most or even all of the functions in certain embodiments of the invention can be automated and/or pre-programmed, to minimize the need for operator input and/or risk of operator error and/or wasted time/energy/etc. These functions include, by way of example, size/shape/position of the DPF (for example, common/standard models can be programmed and an operator can select the appropriate one from a list), vibration, cycle times, position and/or movement pattern/speed of the head(s) 700 in relation to the DPF(s), air pressure, and/or other operations. In certain embodiments, the system can automatically load and position the DPF, the operator can select the DPF model/brand (and/or the system can sense/read that from the DPF itself if that information is available on the DPF), the system can have pre-programmed auto-sizing/patterning for the relative movement of the head(s) 700 with respect to the DPF (based on the DPF model, the head(s) 700, and other factors), the system can include a pre-timed or auto-sensing shut-off, and other programmable features can be provided. In certain embodiments, optical and/or pressure/other sensors preferably are positioned within the apparatus to measure and determine whether the DPF is “clean” for purpose of shutting off the cleaning cycle (by monitoring the air clarity as discussed elsewhere, the back-pressure on the DPF as it is being cleaned, and/or other indicia). Persons of ordinary skill in the art will understand that such functions preferably can be set, selected, controlled, and/or customized from a centralized control panel such as display 300.

As discussed herein, the DPFs can be heavy and/or large (and persons of ordinary skill in the art will understand that DPFs exist in many different shapes and sizes other than the generally cylindrical shape shown in the drawings), and in any case the quality of the cleaning process result depends at least in part on the system cleaning the entire DPF (rather than just cleaning some of the DPF cells). Preferably, the present inventions facilitate such complete cleaning of DPFs in an efficient manner. To assist in that regard and to provide other benefits, certain embodiments of the invention preferably include apparatus to manually or automatically adjust and position the DPF filter(s) with respect to the cleaning head(s) 700. DPFs vary in size, length, and diameter, and other filters for which the present inventions may be useful may come in other shapes and sizes as well. Preferably, such apparatus enables the DPF to be aligned in parallel with and along a desired cleaning/rotational axis between the head(s) 700. In addition to axial alignment, such apparatus also preferably can move the DPFs vertically, laterally between the cabinet sides 203/204, and laterally toward/away from the front of the cabinet 202. As mentioned above, preferably these settings can be pre-programmed into the system's controls to match a given brand/model of DPF, and can be accessed/selected via a control panel 300, or via remote control or any other suitable control and/or actuation technology. Among the many ways to provide such adjustability, a platform 900 preferably can be supported by one or more adjustable rods 902/904 (FIG. 5), and a tiltable support cradle 906 can be operatively positioned on the platform 900. Initial positioning and post-cleaning removal of the DPF onto/from the cradle 906 or otherwise into the cabinet 200 can be accomplished by any suitable means, including for example by hand or by an overhead winch/hoist/crane (not shown) lowering/raising the DPF through the open hatch 206, by providing a retractable mounting rack and/or separate cart in-and-out of the front of the cabinet 202, etc. In such embodiments, the front cabinet doors preferably would be sealed to prevent debris/ash from escaping around them from the interior of the cabinet 200. Preferably, the rack and/or cart can be adjusted vertically to the proper height, so that the DPF is properly positioned with respect to the cleaning heads 700 for cleaning.

Persons of ordinary skill in the art will understand that the present inventions can be utilized in an overall process that also includes testing the DPF before and/or after cleaning on an air flow bench, to determine whether it has been sufficiently cleaned. Likewise, a kiln can be used in processes with the present inventions, to “bake” a DPF and thereby turn any remaining debris into ash, which ash can then be blown out in the cabinet 200 during a subsequent cleaning cycle.

Persons of ordinary skill in the art will understand that the present inventions thus provide substantial improvements in the ease and efficiency of cleaning DPFs and similar items. In certain embodiments of the invention, the apparatus can provide some or all of automated mounting and/or alignment of DPFs within a cleaning chamber, and an automated cleaning process. An operator can push one or a few buttons or select one or a few options, and then walk away from the cabinet and do something else while the machinery cleans the DPF. It reduces the time that someone is required to stand beside the cabinet and monitor/check the status of the operation, etc.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, for claims where the absent feature or component is excluded by way of a proviso or similar claim language, that lack of mention or discussion of a feature, step, or component can provide the basis for coverage by such a claim.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical, or physical partitioning and/or configurations may be implemented to provide the desired functions and/or features of the present invention. Also, a multitude of different constituent module names other than those used and/or depicted herein may be applied to the various partitions. Additionally, with regard to flow diagrams, operational descriptions and method claims, unless the context dictates otherwise, the order in which the steps are presented herein is not intended to mandate that various embodiments be implemented to perform the recited functionality in the same order.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements, and/or components of the invention may be described or claimed in the singular, unless limitation to the singular is explicitly stated, the plural is contemplated to be within the scope thereof.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein may be described in terms of exemplary block diagrams, flow charts, and/or other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. In other words, the present invention is not intended to be limited to the embodiments shown herein but is to be accorded the widest scope consistent with the relevant principles and features disclosed herein.

1. Apparatus for cleaning a diesel particulate filter, including:
at least one cleaning head on each of two ends of the filter, each of said cleaning heads sized and shaped to operatively cover a plurality of cells on one of the ends of the filter simultaneously;
at least one movable guide control for each of said heads, said guide control configured to move said head relative to the respective end of the filter so that all cells in the filter eventually are covered by the head;
said guide control staggering the cells with respect to time, so that no single cell is simultaneously covered by a head on each end of the cell;
a cabinet in which the filter and said heads are positioned during cleaning of the filter, said cabinet having a relatively upper area in which an air filter is positioned and a relatively lower area having a structure to catch solid debris that is dislodged from the filter during cleaning.

2. The apparatus of claim 1, wherein a mounting element holds the filter in a generally horizontal orientation during the cleaning process.

3. A method of cleaning a diesel particulate filter, including the steps of:
providing the apparatus of claim 1;
placing the filter into operative position within the cabinet;
actuating the cleaning heads to blow air and move across both ends of the filter, covering all of the cells of the filter;
using the air filter to remove airborne particulates from inside the cabinet; and
catching solid debris that is dislodged from the filter during cleaning in the structure in the relatively lower area of the cabinet.
